(19) United States
(12) Patent Application Publication
(10) Pub. No.: US 2017/0174445 A1
(43) Pub. Date: Jun. 22, 2017

(54) APPARATUS FOR MOVING PORTIONS

(71) Applicant: Weber Maschinenbau GmbH Breidenbach, Breidenbach (DE)

(72) Inventors: Marco Nichau, Bad Laasphe (DE); Christoph Eckhardt, Breidenbach (DE)

(21) Appl. No.: 15/381,999

(22) Filed: Dec. 16, 2016

(30) Foreign Application Priority Data
Dec. 22, 2015 (DE) 102015122634.0

(51) Int. Cl. B65G 47/68

(52) U.S. Cl. CPC B65G 47/681; B65G 2201/0202

(57) ABSTRACT

The invention relates to an apparatus for moving portions that comprise at least one slice cut off from a food product, in particular by means of a slicing apparatus, in particular by means of a high-sped slicer, having a plurality of individually movable transport movers or transport movers respectively movable as a combined unit for the transport of the portions, having a path system for the transport movers in which the transport movers are movable along at least one predefined path in a direction of transport; and having a control device for controlling the movements of the transport movers in the path system, wherein the transport movers each comprise at least one rotor cooperating with the path system and at least one carrier for portions attached to the rotor; and wherein the path system comprises a plurality of receiver tracks for a multi-track reception of portions in a portioning region and at least one placement track that is associated with a plurality of reception tracks for the placement of portions in a placement region.

The invention relates to an apparatus for moving portions that each comprise at least one slice cut off from a food product, in particular by means of a slicing apparatus, in particular by means of a high-speed slicer.

Conveyor systems are in particular required in the production of single-sort or multi-sort packs which include one or more portions of, for example, slices of sausage and/or cheese to supply the slices of food produced by means of one or more slicing apparatus, in particular by means of so-called slicers, and forming portions or at least part portions to a packaging machine.

The conveyor system serves in practice not only for the transport of the portions from the slicer to the packaging machine, but rather has to satisfy additional functions which are dependent on the respective application, which are generally familiar to the skilled person and of which only buffering and format formation in accordance with the demands of a packaging machine should be named by way of example at this point. In addition, portioning work and completing work may have to be satisfied directly subsequent to the slicer. Furthermore, the portions are typically weighed in practice in the region of the path, i.e. in the region of the conveyor line.

A so-called multi-track operation in which a plurality of food products are sliced simultaneously by means of a slicer is additionally becoming more and more important. A simultaneous slicing can also take place by a plurality of respective single-track slicers working in parallel. The downstream conveyor system has to be capable of such a multi-track operation and must above all be able to form those formats, also called format sets, from the portions produced in the respective number of tracks which can be conveyed to or processed by the downstream packaging machine.

This object and further objects of a conveyor system in the field of handling portions of slices cut off from food products, in particular food products of loaf or bar shape, by means of slicers are currently satisfactorily achieved using conveyor belt systems. Conveyor belt systems are, however, associated with a high mechanical effort and are generally configured for handling a stream of products. It is not possible or is at best only possible with limitations to influence an individual portion using a conveyor belt system. In addition, the transitions between consecutive conveyor belt sections are e.g. in particular problematic with respect to the required gentle transport of the portions. Furthermore, only straight conveyor lines or conveyor lines comprising straight-line sections can naturally be implemented with conveyor belts, i.e. the flexibility in the design of a conveyor line is limited in conveyor belt systems. The possibilities of the total system are equally limited, e.g. with respect to the products to be processed and the formation possibilities of the portions and formats. In addition, a comparatively high effort is required in the cleaning in association with conveyor belt systems used in the food sector to be able to observe the high hygiene standards.

A transport apparatus is also known, e.g. from DE 10 2014 106 400 A1, having a plurality of individually movable transport movers or respective transport movers movable as a combined unit and having a path system for the transport movers in which the transport movers are movable in a direction of transport along at least one predefined path. A control device in this respect controls the movements of the transport movers in the path system. Individual portions can be handled and individual portions can be influenced in the region of conveyor lines and other lines, e.g. sorting lines, using such an apparatus.

Such a movement apparatus has a number of advantages with respect to conventional conveyor belt systems. The portions can, for example, thus be transported from the receiver up to the placement without any further portion transfer. In comparison with this, conveyor belt systems have a number of transitions between individual belts. These transitions may possibly negatively influence the portions, e.g. their design or structure. Portion transfers are avoided or at least minimized by the path system. Sensors can furthermore be saved that are necessary e.g. as light barriers for checking the positions of the portions in conveyor belt systems.

The transport movers each comprise at least one rotor cooperating with the path system and at least one carrier for portions attached to the rotor. Each transport mover or each transport mover unit preferably transports a portion directly or indirectly on the carrier. Alternatively, a plurality of portions can also be received on a carrier. A plurality of transport movers, e.g. two transport movers following one another directly, can also together transport one or more portions.

A transport system which can generally be used for this purpose and to which reference will explicitly be made with respect to the requirement of performability is offered by the company MagneMotion, Inc., domiciled in Devens, Mass., USA. This system is based on a so-called LSM drive, that is on a drive by linear synchronous motors which is to be distinguished from a so-called linear induction motor (LIM drive). Unlike an LIM drive, in an LSM drive, a magnetic field is not induced by means of the so-called electromagnetic traveling field, but the magnetic field is provided by permanent magnets. When the rotor of the linear motor carries the permanent magnets and the stator of the linear motor produces the electromagnetic traveling field, the drive principle of an LSM drive can be figuratively imagined such that the transporter provided with the permanent magnet is pulled over the transport line by the magnetic field moving along the stator. Such a transport system or drive principle is described, for example, in WO 2003/029651 A2 and WO 2010/085670 A1. Reference is herewith explicitly made to this document with reference to the disclosure of a possible drive principle or functional principle for the invention.

It is disadvantageous in such movement apparatus, however, that standstills of the transport movers and accompanying braking and acceleration processes occur due to the path guidance. These processes cost energy unnecessarily, on the one hand. On the other hand, there is the risk that the portions slip on the carriers.

It is therefore an object of the invention to improve an apparatus for moving portions such that a portion stream to the placement region is achieved that is as continuous as possible and standstills of the transport movers are avoided.

This object is satisfied by an apparatus as defined in the apparatus claims, by a method having the features as defined in the method claims, and by a coupling apparatus having the features as defined in the coupling apparatus claims.

In accordance with the invention, the path system comprises a plurality of receiver tracks for a multi-track reception of portions in a portioning region and at least one placement track that is associated with a plurality of receiver tracks for placing portions in a placement region.

The term “portion” is to be understood as broad within the framework of the invention. A portion can accordingly consist of only one single slice. Alternatively, a portion can comprise a plurality of slices which can be present in a relative arrangement of generally any form, for example in a so-called stacked or overlapping arrangement such as is familiar to the skilled person in the technical field in question here. The portion can be a total portion such as is subsequently packaged and offered for sale on the market. Alternatively, the portion can be a part portion which only forms a total portion together with one or more further part portions which can in turn each comprise one or more slices. The part portions of a total portion can be formed from different product sorts so that a multi-sort portion can be produced by assembling a plurality of part portions and so that a multi-sort pack is thus present after its packaging. The slices can, for example, be comparatively thin slices such as are generally known in the form of assorted slices of sausage or of cheese. Alternatively, the slices can each be pieces that are relatively thick in comparison with assorted slices such as pieces of fresh meat. A multi-sort portion can comprise slices of different sorts, shapes and/or depositing shapes. In accordance with the invention, a plurality of respective single-sort packages can furthermore also be mixed and can be supplied to a common outer package in a predefinable ratio.

In other words, a portion within the framework of the invention is the unit which is the smallest with respect to the transport task, which has to be transported over a specific line, on the one hand, and which optionally—depending on the application—additionally has to be put into relation with further portions, on the other hand, to satisfy the respective demands of the total system which comprises one or more slicing apparatus, in particular slicers, the path system, and one or more packaging apparatus. For example, with respect to the forming of formats such as have to be provided for the respective provided packaging apparatus.

A transport mover can transport one or more portions. It is alternatively also possible that a plurality of transport movers, in particular two transport movers, together transport at least one portion and form a combined unit. The transport movers can in this respect be moved so-to-say as a unit on the path system, which is also called a “tandem mover”. The transport movers can have one common carrier or a plurality of carriers. Larger loads, in particular heavier portions and/or portions larger in area, can thereby also be moved on the path system than with only one transport mover.

The placement tracks can in particular be associated with all or some of the plurality of receiver tracks. The number of placement tracks is thus preferably smaller than the number of receiver tracks. Only one single placement track for all receiver tracks is particularly preferably provided, i.e. the placement always takes place in one track starting from a single track. Two, three, four, five or more receiver tracks can in particular be provided.

The receiving of a portion can take place in the portioning region in that the portion is received directly from a slicing apparatus. In this case, cutting can be directly onto the carrier of the transport mover. The portion can subsequently be moved on the transport mover through the total system, in particular including a placement of the portion at a packaging apparatus in the placement region. The total system can in this respect be configured as a path system.

It is alternatively also possible that the transport movers only receive the carriers, with or without a portion, in the portioning region.

Alternatively, the portion or a carrier can be transferred from a conventional conveying device, e.g. from a conveyor belt, to the transport movers. Cutting can thus first take place on a conveyor belt, for example, and the portion can be transported off. A transfer of the portion from the conveyor belt to a path system can subsequently take place. This path system can serve as a multifunctional intermediate member between the slicing apparatus and a packaging apparatus. The portions can either be transferred directly to the packaging apparatus or e.g. first to a feed apparatus, e.g. to a feed belt, via which the portion then moves to a packaging apparatus.

For reasons of simplicity, both the above-explained variants are combined under the term “portioning apparatus” in the following. The portioning apparatus can thus be either a single-track or a multi-track slicing apparatus or a conventional conveying device from which the portions or the carriers respectively move onto the transport movers.

A plurality of portioning apparatus can be provided in the portioning region. A separate receiver track can be associated with each portioning apparatus. A separate receiver track is preferably associated with each track of a multi-track slicing apparatus. A plurality of products, also different products, can be simultaneously cut and transported away in this manner.

The placement region can be a packaging region, that is the region at which the portion is packed or is transferred to a packaging apparatus. However, those regions are also to be understood under the term “placement region” in which the products are, for example, transferred to a conventional conveying device or to a processing device, e.g. to a weighing device. A placement track is preferably associated with a single-track feed. With a multi-track feed, a separate placement track can be provided for each track.

Since a packaging apparatus can frequently package more portions per unit of time in practice than a single slicing apparatus can produce, the transport movers may have to be temporarily buffered in conventional path systems, which is associated with standstills. Since one placement track is associated in accordance with the invention with a plurality of receiver tracks, which can receive portions of a plurality of slicing apparatus, for example, the transport movers can be continuously moved. Only those transport movers preferably move into the placement region that are loaded with one or more portions. Breaks during slicing can in particular be compensated by the separate receiver tracks, the breaks being able to occur, for example, by loading processes and by prematurely reached cutting ends with short product bars or with product bars of different lengths, in particular in the case of natural products.

Standstill times and braking and acceleration processes associated therewith can consequently be minimized by the invention at least for loaded transport movers. The transport movers guided in the path system are thereby practically only exposed to sliding friction. Slow movements and standstills which would result in stiction are avoided or at least kept small at least for loaded transport movers.

Further developments of the invention can also be seen from the dependent claims, the description and the enclosed drawings.

In accordance with an embodiment the receiver tracks are of different lengths. The transport movers on the different receiver tracks can be automatically matched to one another with a corresponding control of the transport movers or of the slicing apparatus. The receiver tracks thereby form buffers of different lengths. The transport movers are thus automatically matched to one another such that a merging of the receiver tracks has a particularly simple design, with the speeds of the transport movers not having to be matched or only having to matched a little.

In accordance with a further embodiment, the receiver tracks are consecutively merged with one another. This can, for example, be achieved particularly simply by receiver tracks of different lengths. Due to receiver tracks of different lengths, the latter are automatically led together consecutively—and not at a common point. Two respective receiver tracks are preferably consecutively merged. The receiver tracks are in particular led together in a staggered or cascade-like form in the manner of a “zipper merge system” in road traffic. Unlike with a simultaneous leading together of a plurality of receiver tracks, no congestion thus occurs at the merge points.

Provision can alternatively or additionally be made that the receiver tracks are first respectively merged groupwise onto at least one intermediate track and the intermediate tracks are subsequently merged onto the placement track. Such a parallel process can make possible a more efficient or more flexible handling of the receiver tracks or of the respective transport movers coming from them in dependence on the respective application. It is, for example, possible to guide the individual groups of receiver groups or the individual intermediate tracks independently of one another so that optionally provided functional regions e.g. do not have to be simultaneously associated with all receiver tracks.

In accordance with a further embodiment, the merging of the receiver tracks always takes place from the same side. The transport movers are thus filtered in at one side. This is in particular helpful when transport movers designed at one side, e.g. projecting and/or asymmetrical transport movers, or correspondingly designed carriers for the transport movers are used. The merging of the receiver tracks can, however, alternatively also take place from different sides. A two-sided filtering in is in particular advantageous with symmetrically designed transport movers or carriers.

In accordance with a further embodiment, points are provided which merge the receiver tracks. The leading together of the receiver tracks can be implemented in a particularly simple manner by points. A normal path segment, in particular a straight-line path segment, can be provided between two points. The points are thus preferably not directly concatenated with one another. The path segments between the points that are in particular short in relationship to the respective total lengths of the receiver tracks can each be of the same or of different lengths. Relatively short buffer lines dimensioned in dependence on the application can be provided in this manner.

In accordance with the invention, the transport movers thus cover routes of different lengths in the individual receiver tracks. A higher performance or a higher throughput thereby results on the leading together of the transport movers in comparison with a direct sequence of points. This also results from the fact that the control can be configured always to keep the transport movers in motion, with the path segment being able to serve in each case as a small buffer line up to the next points.

In accordance with a further embodiment, the placement track splits into a plurality of receiver tracks subsequent to the placement region. Points can be provided for this splitting, for example. The placement track can thus be fanned out again in order e.g. to be able to supply the transport movers to the portioning apparatus in different tracks again after the placement of the portion.

In accordance with a further embodiment, the receiver tracks and the placement track are components of a closed round line of the path system that leads from the portioning region into the placement region and back to the portioning region. The round line thus in particular comprises a multi-track portioning region for the multi-track reception of portions; a region in which the receiver tracks are led together; a placement region in which the portions are placed down—preferably in a single placement track; and a region in which the placement track is again fanned out into a plurality of tracks.

In accordance with a further embodiment, the path system comprises at least one buffer region, preferably in front of the placement region in the direction of transport, that has a higher path density or line density than regions disposed directly upstream and downstream of the buffer region. The buffer region is in particular formed by a single-track or multi-track buffer line whose length is larger, in particular substantially larger, than the shortest distance between the start and the end of the buffer region. The length of the buffer line preferably amounts to a multiple of the shortest distance between the start and the end of the buffer region.

The invention also relates to a method of continuously supplying portions to a packaging apparatus using an apparatus in accordance with the invention. The transport movers take up portions in a plurality of receiver tracks in the portioning region. The transport movers are subsequently consecutively led together from at least some of the receiver tracks onto the same placement track. Finally, the portions are placed down from the placement track in the placement region.

In accordance with a further embodiment, respective predefined or predefinable intervals between the transport movers are set during and/or after the leading together of the transport movers. A continuous placement of the portions can thus be achieved. This interval formation forms a basis for a synchronous transfer of the portions. The portions can e.g. be transferred to packages since then respective rows or lines already comprising a respective plurality of portions are present.

The requirement for portions to be placed can be detected and can be taken into account accordingly by the portioning apparatus and/or the slicing apparatus. Mixed portions can thus be produced, for example, with a directly predefinable ratio of the different product sorts.

In accordance with a further embodiment, a respective predefined or predefinable order of the transport movers is set during and/or after the leading together of the transport movers. Mixed portions can thus be prepared in a simple manner, for example. It can e.g. also be set that first a specific number of portions of a sort A are packed and subsequently a specific number of portions of a sort B are packed. The order of the transport movers can also be set such that a desired target weight of a total portion is e.g. reached when a plurality of portions move into a package as part portions. In this respect, transport mover having underweight or overweight portions are correspondingly strung in a line. The weight determination can take place in the portioning region, for example.

In accordance with a further embodiment, a transport mover is only moved from the portioning region in the direction of the placement region when it is loaded. If, for example, a portion is missing at the slicing apparatus, the transport mover does not move off. Gaps thereby do not arise and empty transport movers do not move unnecessarily in the path system. Transport movers loaded with portions are thus not impeded.

The invention also relates to a coupling apparatus, in particular for an apparatus in accordance with the invention or in combination with an apparatus in accordance with the invention. The coupling apparatus is configured to couple a plurality of part lines of a path system to one another on which a plurality of individually movable transport movers or transport movers respectively movable as a combined unit are provided. The transport movers are movable in a direction of transport along at least one predefined path by means of a control device and each comprise at least one rotor cooperating with the path system and at least one carrier attached to the rotor.

The coupling apparatus comprises at least one path module having line sections that can be at least partly integrated into the part lines and connection sections extending between the part lines. Different part lines can thus be connected to one another, in particular in the manner of a cascade.

In accordance with an embodiment, the part lines are functional lines that each lead from a portioning region to a placement region and back. The functional lines can, for example, connect a portioning apparatus to a packaging apparatus. The functional lines can also provide the function of a feed. The coupling apparatus thus in particular allows a joining together of a plurality of cutting lines oriented substantially in parallel.

In accordance with a further embodiment, part lines coupled by means of the path module each comprise a forward run and a backward run, with the path module being able to be integrated into the path system such that transport movers moved through the path module change from forward run to forward run or from backward run to backward run to change part lines. The changing of the part lines can take place by means of points, for example.

In accordance with a further embodiment, the line sections comprise integration sections that can be integrated into the part lines and short-cut sections that connect the integration sections and shorten the path of the respective part line. The integration sections thus respectively replace a section of the respective part line. Due to the short-cut sections, a transport mover can, for example, bypass a portioning region and/or a placement region and can thus e.g. be moved faster to the desired location. It is then e.g. also possible not to travel to a placement region when no portion is present on the transport mover.

The flexibility of the apparatus can hereby be hugely increased since, in dependence on their respective power parameters, e.g. load with product bars, cutting performance and placement performance, the transport movers can change to and fro as required between the individual part lines, in particular individual cutting lines, in accordance with the invention.

In accordance with a further embodiment, part lines coupled by means of the path module each comprise a forward run and a backward run, with the path module comprising functional sections provided in pairs, in particular integration sections, short-cut sections and/or connection sections, and in each pair the one functional section being associated with the forward run and the other functional section being associated with the backward run of a respective part line.

In accordance with a further embodiment, part lines coupled by means of the path module extend at least substantially in parallel with one another, with the path module being at least substantially of T shape and comprising two connection sections, two integration section and two short-cut sections that each extend at least substantially in parallel with one another. The connection sections can in particular extend in parallel with the short-cut sections. The integration sections can be arranged at a right angle hereto.

In accordance with a further embodiment, a separate control, a control corresponding to the path system and/or an apparatus for connection to the control device of the path system is provided for the path module. The coupling apparatus can accordingly be configured as a standardized unit that can be integrated into a path system in a modular manner. The components of the coupling apparatus can be preconfigured so that a fast integration is possible. The interfaces and dimensions can in particular be standardized. The manufacture can thus also take place in a standardized manner. The control of the path module can, however, also simply be taken over by the path system control.

The coupling apparatus can, for example, be planned and installed as a prefabricated unit in path systems since the operating behavior, in particular in an interplay of a plurality of points, and/or the influence of the included sections as buffers for the transport movers is/are known.

All the embodiments of the apparatus described here are in particular configured to be operated in accordance with the method described here. Furthermore, all the embodiments of the apparatus described here as well as all the embodiments of the method described here can each be combined with one another.

The invention will be described in the following by way of example with reference to the drawings. There are shown:

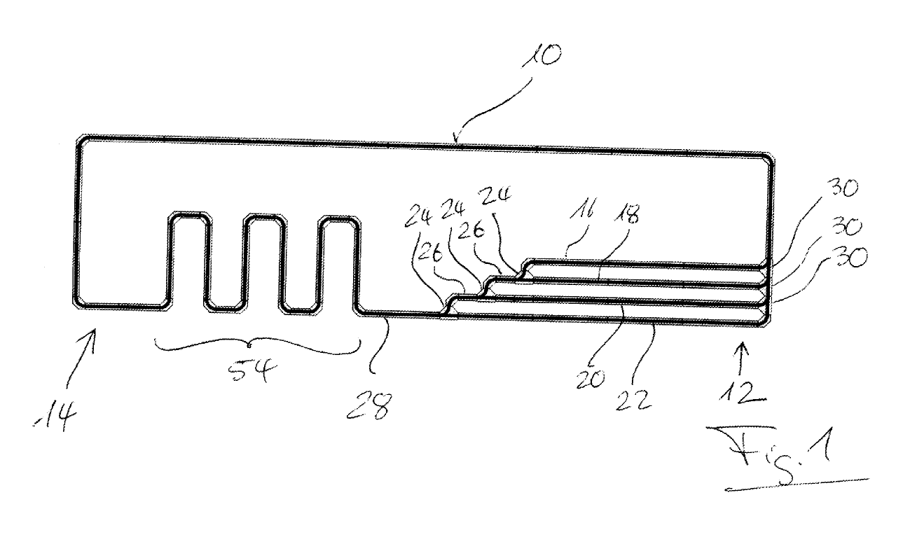

FIG. 1 a schematic plan view of an embodiment of a movement apparatus in accordance with the invention;

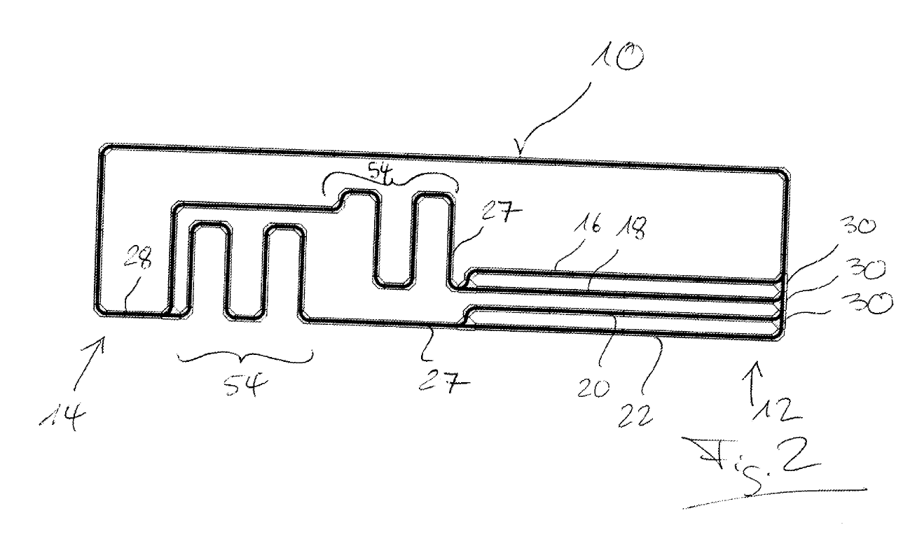

FIG. 2 a schematic plan view of a further embodiment of a movement apparatus in accordance with the invention;

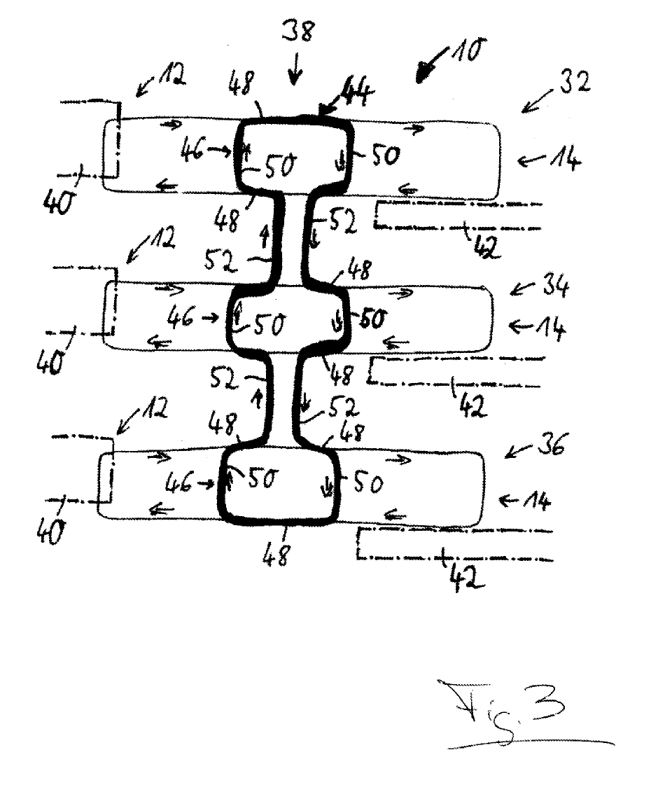

FIG. 3 a schematic plan view of an embodiment of a movement apparatus with a coupling apparatus in accordance with the invention; and

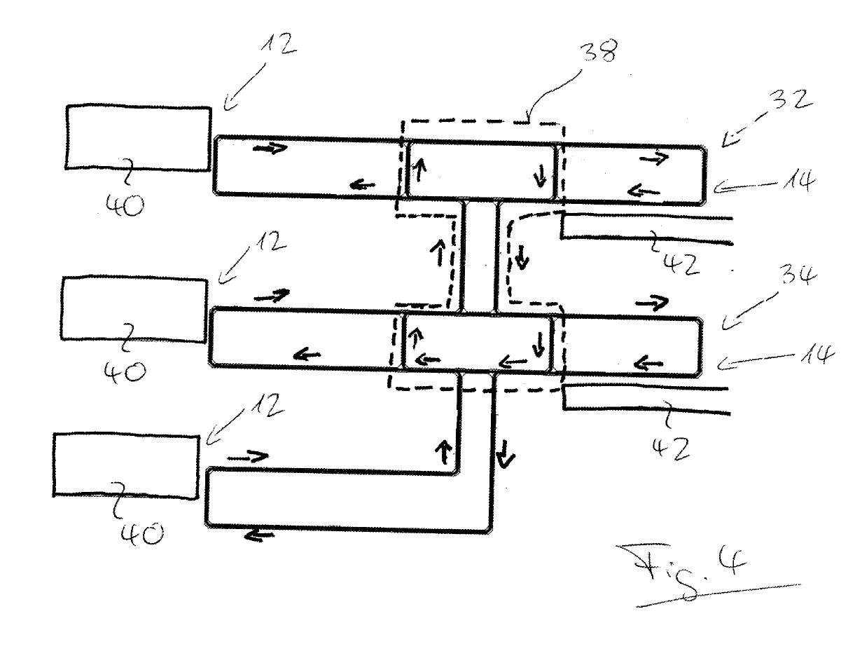

FIG. 4 a schematic plan view of a further embodiment of a movement apparatus with a coupling apparatus in accordance with the invention.

It must first be noted that the embodiments shown are of a purely exemplary nature. The number of tracks and part lines can in particular vary. The features of an embodiment can also be combined as desired with features of another embodiment.

FIG. 1 shows a path system 10 configured as a round line and having a portioning region 12 and a placement region 14. Transport movers, not shown, can be moved on the path system 10.

One or more portioning apparatus, e.g. slicing apparatus or conveyor units, having a respective one or more tracks can be provided in the portioning region 12. A separate receiver track 16, 18, 20, 22 is associated with each track of the portioning apparatus. Each of the four receiver tracks 16, 18, 20, 22 is first supplied to a track of the portioning apparatus. A transport mover moved on this receiver track 16, 18, 20, 22 receives a portion in so doing.

The transport movers can all be led past the positioning apparatus with the same longitudinal alignment. Alternatively, one or more receiver tracks 16, 18, 20, 22 can also extend at least partly transversely thereto to be able to receive a portion having a different orientation on the transport mover.

The receiver tracks 16, 18, 20, 22 are successfully led together and thus merged via points 24. The receiver tracks 16, 18, 20, 22 are of different lengths. The shortest receiver track 16 is thus first merged via points 24 with the second-shortest receiver track 18. After one path segment 26, the receiver tracks 18 and 20 are led together via further points 24. A further path segment 26 follows before the receiver tracks 20 and 22 are merged. The path segments 26 between the points 24 can be of the same construction and in particular of the same length. A buffering of the transport movers can take place between the points 24 due to the path segments 26.

Once the receiver tracks 16, 18, 20, 22 have been merged, a single placement track 28 remains. The portions are placed from this placement track 28 in a placement region 14, for example to a packaging apparatus or to a conveyor unit, e.g. to a feed belt. Subsequent to the placement region 14, the placement track 28 is led back again and is split into the receiver tracks 16, 18, 20, 22 via points 30.

In accordance with the invention, empty transport movers are first guided in one track out of the placement region 14 in the direction of the portioning region 12. The transport movers are distributed over the receiver tracks 16, 18, 20, 22 via the points 30 in the positioning region 12. The transport movers branch onto these secondary lines to receive portions. The transport movers are subsequently gradually led together onto the same placement track 28. The receiver tracks 16, 18, 20, 22 are merged by the points 24 for the leading together. Path segments 26 can serve as buffers in this process. The order and/or the spacing between the transport movers can be fixed on the leading together.

FIG. 1 additionally shows a possibility of how, when required, an additional functional region can be provided, here a buffer region 54 disposed in front of the placement region 14, simply by an intelligent line guidance. A region is created by a line guidance that comprises a plurality of bows and is so-to-say meandering and that has a relatively higher path density or line density than regions of the path system 10 disposed directly upstream and downstream. The buffer line consequently has a length that is substantially larger than the shortest distance between the start and end of the buffer region 54. In the example shown, the path is formed in one track in the buffer region 54. Alternatively, to multiply the buffer capacity for the buffer region 54, a multi-track line guidance can be provided that is integrated into the otherwise single-track path by points at the input side and at the output side.

The portions are subsequently placed down in the placement region 14 and e.g. packed. In accordance with the invention, a continuous portion stream to the packaging apparatus is made possible in this manner.

The path system 10 in accordance with FIG. 2 differs from the path system of FIG. 1 with respect to the manner of the leading together of the receiver tracks 16, 18, 20 and 22 onto the placement track 28. The receiver tracks are here not merged individually one after the other, but rather groupwise onto a respective intermediate track 27. The group formed by the receiver tracks 16 and 18 and the group formed by the receiver tracks 20 and 22 are merged in parallel so that two intermediate tracks 27 are present. After running through a respective buffer region 54 in accordance with the embodiment of FIG. 1, the two intermediate tracks 27 are merged onto the placement track 28 before the placement region 14.

FIG. 3 shows a path system 10 having three adjacent part lines 32, 34, 36 that are connected to one another via a central coupling apparatus 38 that is emphasized by a thicker line in FIG. 3.

The part lines 32, 34, 36 can each comprise a portioning region 12 in which portions each move onto the transport movers by a slicing apparatus 40 and a placement region 14 in which the portions are each placed at a packaging apparatus 42.

The coupling apparatus 38 comprises a path module 44 having line sections 46 that comprise integration sections 48 that are integrated into the part lines 32, 34, 36 and short-cut sections 50 that connect the integration sections 48 and shorten the respective part lines 32, 34, 36.

The path module 44 furthermore comprises connection sections 52 that extend between the part lines 32, 34, 36 and connect them to one another. A connection can be established to adjacent part lines 32, 34, 36 in this manner.

Starting from the part line 36, a connection section 52 branches off via points between the portioning region 12 and the placement region 14. This connection section 52 serves as a supply to the adjacent part line 34. The connection section 52 opens into this part line 34 in the route from the placement region 14 to the portioning region 12, and indeed in the upstream direction in front of the short-cut section 50 viewed in the direction of the portion flow.

The short-cut section 50 is located within the part line 34 and forms a parallel line or bypass of the route to the portioning region 12. The short-cut section 50 opens via points into the integration section 48 that leads to the placement region 14 of the part line 34.

A further parallel short-cut section 50 that bypasses the placement region 14 of the part line 34 branches off from this integration section 48. The short-cut section 50 opens into the integration section 48 coming from the placement region 14. Further points, from which a second connection section 52 branches off and leads back to the part line 36 again, is located downstream therefrom viewed in the direction of the portion flow. The opening takes place between the portioning region 12 and the placement region 14.

The part lines 34 and 32 can correspondingly also be connected to one another. The portioning region 12 and the placement region 14 can also be swapped over.

The coupling apparatus in accordance with the invention can also connected any desired part lines to one another. The part lines are consequently not necessarily lines between a portioning region 12 and a placement region 14. Any other products in addition to foods can thus also be transported between functional regions of any configuration.

The embodiment in accordance with FIG. 4 shows that the number of slicing apparatus 40 does not have to correspond to the number of packaging apparatus 42. The portions produced by means of the slicing apparatus 40 at the bottom in FIG. 4 can be channeled into the part liens 32, 34 of the other two slicing apparatus 40. Transport movers can be channeled out of these part lines 32, 34 and supplied to the lower slicing apparatus 40. The two part lines 32, 34 and the lower slicing apparatus 40 are connected by a coupling apparatus 38 that is indicated by a surrounding dashed line in FIG. 4 and that generally corresponds to the coupling apparatus 38 of FIG. 3 with respect to design and operation.

### REFERENCE NUMERAL LIST

10 path system
12 portioning region
14 placement region
16, 18, 20, 22 receiver track
24 points
26 path segment
27 intermediate track
28 placement track
30 points
32, 34, 36 part line
38 coupling apparatus
40 slicing apparatus
42 packaging apparatus
44 path module
46 line section
48 integration section
50 short-cut section
52 connection section
54 buffer region

1. An apparatus for moving portions that each comprise at least one slice cut off from a food product,
having a plurality of individually movable transport movers or transport movers respectively movable as a combined unit to transport the portions;
having a path system for the plurality of transport movers in which the plurality of transport movers are movable in a direction of transport along at least one predefined path; and
having a control device for controlling the movements of the plurality of transport movers in the path system,
wherein the plurality of transport movers each comprise at least one rotor cooperating with the path system and at least one carrier for portions attached to the rotor; and
wherein the path system comprises a plurality of receiver tracks for a multi-track reception of portions in a portioning region and at least one placement track that is associated with at least some of the plurality of receiver tracks for placing down portions in a placement region.

2. The apparatus in accordance with claim 1,
wherein the plurality of receiver tracks are of different lengths.

3. The apparatus in accordance with claim 1,
wherein the plurality of receiver tracks are consecutively merged with one another; or wherein the plurality of receiver tracks are respectively merged groupwise onto at least one intermediate track and the intermediate tracks are subsequently merged onto the at least one placement track.

4. The apparatus in accordance with claim 3,
wherein the merging of the plurality of receiver tracks always takes place from the same side.

5. The apparatus in accordance with claim 1,
further comprising points that merge the plurality of receiver tracks.

6. The apparatus in accordance with claim 1,
wherein the at least one placement track splits into a plurality of receiver tracks subsequent to the placement region; and/or wherein points are provided that split the at least one placement track.

7. The apparatus in accordance with claim 1,
wherein the plurality of receiver tracks and the at least one placement track are components of a closed round line of the path system that leads from the portioning region into the placement region and back to the portioning region.

8. The apparatus in accordance with claim 1,
wherein the path system comprises at least one buffer region that has a higher path density than regions disposed directly upstream and downstream of the buffer region and/or that is formed by a single-track or multi-track buffer line whose length amounts to a multiple of the shortest distance between the start and the end of the buffer region.

9. A method for the continuous supply of portions to a packaging apparatus having an apparatus in accordance with claim 1,
wherein the plurality of transport movers receive portions in a plurality of receiver tracks in the portioning region;
the plurality of transport movers are consecutively led together onto the same placement track from at least some of the plurality of receiver tracks; and
the portions are placed down from the placement track in the placement region.

10. The method in accordance with claim 9,
wherein respectively predefined or predefinable intervals are set between the plurality of transport movers during and/or after the leading together of the transport movers.

11. The method in accordance with claim 9,
wherein a respective predefined or predefinable order of the plurality of transport movers is set during and/or after the leading together of the plurality of transport movers.

12. The method in accordance with claim 9,
wherein a transport mover is only moved from the portioning region in the direction of the placement region when it is loaded.

13. A coupling apparatus for coupling a plurality of part lines of a track system on which a plurality of individually movable transport movers or transport movers respectively movable as a combined unit are provided that are movable by means of a control device along at least one predefined track in a direction of transport and that each comprise at least one rotor cooperating with the path system and at least one carrier attached to the rotor,
wherein the coupling apparatus comprises at least one path module having line sections that can be at least partly integrated into the part lines and comprises connection sections that extend between the part lines.

14. The coupling apparatus in accordance with claim 13, wherein the coupling apparatus is for an apparatus or in combination with an apparatus in accordance with claim 1.

15. The coupling apparatus in accordance with claim 13,
wherein the part lines are functional lines that each lead from a portioning region to a placement region and back.

16. The coupling apparatus in accordance with claim 13,
wherein part lines coupled by means of the path module comprise a respective forward run and a backward run, with the path module being able to be integrated into the path system such that transport movers moved through the path module change from forward run to forward run or from backward run to backward run to change part lines.

17. The coupling apparatus in accordance with claim 13,
wherein the line sections comprise integration sections that can be integrated into the part lines and short-cut sections that connect the integration sections and shorten the path of the respective part line.

18. The coupling apparatus in accordance with claim 13,
wherein part lines coupled by means of the path module each comprise a forward run and a backward run, with the path module comprising functional sections provided pairwise and in each pair the one functional section is associated with the forward run and the other functional section is associated with the backward run of a respective part line.

19. The coupling apparatus in accordance with claim 13,
wherein part lines coupled by means of the path module extend at least substantially in parallel with one another, with the path module being at least essentially of T shape and comprising two connection sections two integration sections and two short-cut sections that each extend at least substantially in parallel with one another.

20. The coupling apparatus in accordance with claim 13,
wherein a separate control, a control corresponding to the path system and/or an apparatus for connection to the control device of the path system is/are provided for the path module.
